(19) United States
(12) Patent Application Publication
(10) Pub. No.: US 2022/0085873 A1
(43) Pub. Date: Mar. 17, 2022

(54) ELECTRONIC DEVICE AND METHOD FOR MONITORING INTERFERENCE SOURCE OF SATELLITE STATION

(71) Applicant: Telecom Technology Center, New Taipei City (TW)

(72) Inventors: Yu-Ming Chen, New Taipei City (TW); Tso-Ling Kuo, New Taipei City (TW); Shan-Hsiung Hsieh, New Taipei City (TW)

(73) Assignee: Telecom Technology Center, New Taipei City (TW)

(21) Appl. No.: 17/079,534

(22) Filed: Oct. 26, 2020

(30) Foreign Application Priority Data
Sep. 16, 2020 (TW) 109131874

(51) Int. Cl. H04B 7/185; H04B 17/318; G01S 5/06

(52) U.S. Cl. CPC H04B 7/18519; G01S 5/06; H04B 17/318

(57) ABSTRACT

An electronic device and a method for monitoring an interference source of a satellite station are provided. The method includes: obtaining a wireless signal; determining whether the wireless signal includes a mobile network signal; demodulating the mobile network signal to obtain a base station identity in response to the wireless signal including the mobile network signal; and outputting the base station identity.

### CROSS-REFERENCE TO RELATED APPLICATION

This application claims the priority benefit of Taiwan application no. 109131874, filed on Sep. 16, 2020. The entirety of the above-mentioned patent application is hereby incorporated by reference herein and made a part of this specification.

### TECHNICAL FIELD

The disclosure relates to an electronic device and a method for monitoring an interference source of a satellite station.

### BACKGROUND

In the past, satellite stations were not affected by too many interference sources, so the satellite stations can maintain better communication quality when communicating. However, as the mobile network technology gradually develops and becomes widespread, the satellite stations are increasingly susceptible to interference from base stations of mobile network. In order to assist an administrator of the satellite station to quickly handle the interference source, it is necessary to propose a method that can efficiently monitor the interference source of the satellite station.

### SUMMARY

The disclosure provides an electronic device and a method for monitoring an interference source of a satellite station, which can automatically obtain a base station identity of the interference source.

The disclosure provides an electronic device for monitoring an interference source of a satellite station, which includes a processor, a storage medium and a first transceiver. The first transceiver receives a wireless signal. The storage medium stores a plurality of modules. The processor is coupled to the storage medium and the first transceiver, and accesses and executes a plurality of modules. The modules include a signal processing module, a demodulating module and an output module. The signal processing module determines whether the wireless signal includes a mobile network signal. The demodulating module demodulates the mobile network signal to obtain a base station identity in response to the wireless signal including the mobile network signal. The output module outputs the base station identity.

In an embodiment of the disclosure, the first transceiver receives the mobile network signal in the wireless signal at a first time point, and the electronic device further includes a second transceiver. The second transceiver is coupled to the processor. The second transceiver receives the mobile network signal in the wireless signal at a second time point. The signal processing module calculates a time difference of arrival according to the first time point and the second time point, and obtains location information corresponding to the base station identity according to the time difference of arrival.

In an embodiment of the disclosure, the output module outputs the location information.

In an embodiment of the disclosure, the signal processing module determines that the wireless signal includes the mobile network signal in response to a first power of the wireless signal in a first frequency band being greater than a first threshold.

In an embodiment of the disclosure, the signal processing module determines that the wireless signal includes an interference signal in response to a second power of the wireless signal in a second frequency band being greater than a second threshold.

In an embodiment of the disclosure, the first transceiver receives the mobile network signal in the wireless signal at a first time point, and the electronic device further includes a second transceiver. The second transceiver is coupled to the processor. The second transceiver receives the interference signal in the wireless signal at a second time point. The signal processing module calculates a time difference of arrival according to the first time point and the second time point, and obtains location information corresponding to the interference signal according to the time difference of arrival.

In an embodiment of the disclosure, the output module outputs the location information.

In an embodiment of the disclosure, the output module outputs the base station identity according to one of a simple mail transfer protocol and a short message protocol.

The disclosure provides a method for monitoring an interference source of a satellite station, including: obtaining a wireless signal; determining whether the wireless signal includes a mobile network signal; demodulating the mobile network signal to obtain a base station identity in response to the wireless signal including the mobile network signal; and outputting the base station identity.

Based on the above, the disclosure can determine whether the interference signal that interferes the satellite station includes the mobile network signal, and can demodulate the mobile network signal to obtain the base station identity, so as to determine which base station is the interference source that interferes the satellite station based on the base station identity.

### BRIEF DESCRIPTION OF THE DRAWINGS

FIG. 1 is a schematic diagram illustrating an electronic device for monitoring an interference source of a satellite station according to an embodiment of the disclosure.

FIG. 2 is a flowchart illustrating a method for monitoring an interference source of a satellite station according to an embodiment of the disclosure.

### DETAILED DESCRIPTION

In order to make content of the disclosure more comprehensible, embodiments are described below as the examples to prove that the disclosure can actually be realized. Moreover, elements/components/steps with same reference numerals represent same or similar parts in the drawings and embodiments.

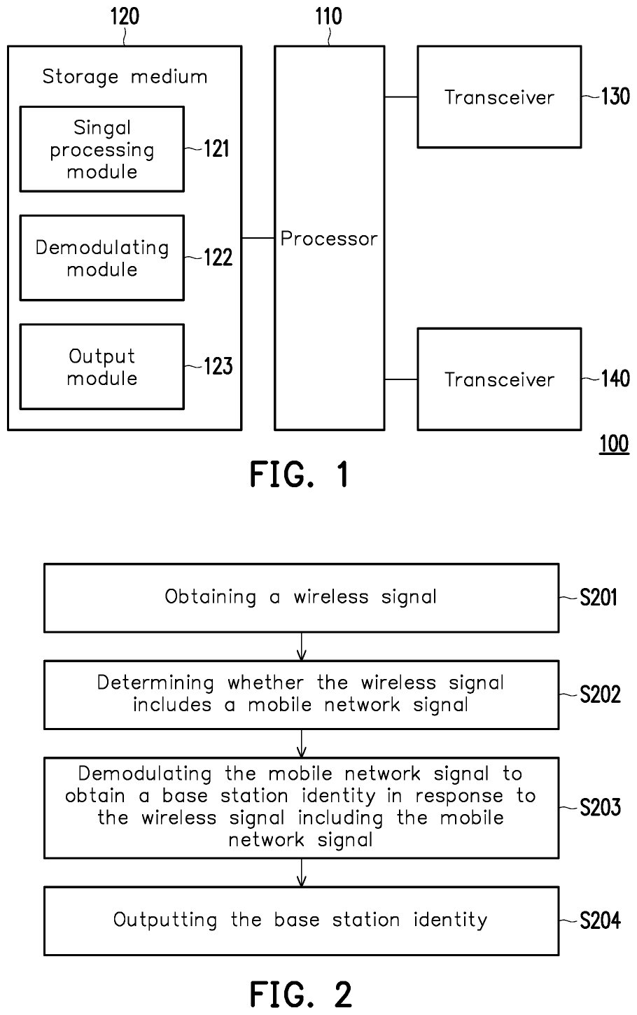

FIG. 1 is a schematic diagram illustrating an electronic device 100 for monitoring an interference source of a satellite station according to an embodiment of the disclosure. The electronic device 100 may include a processor 110, a storage medium 120 and a transceiver 130. In an embodiment, the electronic device 100 may further include a transceiver 140. The electronic device may be configured to monitor the interference source of the satellite station. The electronic device 100 may be, for example, a satellite station or a device arranged around the satellite station.

The processor 110 is, for example, a central processing unit (CPU) or other programmable micro control units (MCU) for general purpose or special purpose, a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA) or other similar elements or a combination of above-mentioned elements. The processor 110 may be coupled to the storage medium 120, the transceiver 130 and the transceiver 140, and may access or execute a plurality of modules and various applications stored in the storage medium 120.

The storage medium 120 is, for example, a random access memory (RAM), a read-only memory (ROM), a flash memory, a hard disk drive (HDD), a hard disk drive (HDD), a solid state drive (SSD) or other similar elements in any stationary or movable form, or a combination of the above-mentioned elements, and is used to store the modules and various applications that may be executed by the processor 110. In this embodiment, the modules stored by the storage medium 120 may include a storage medium 121, a demodulating module 122 and an output module 123, and their functions will be described later.

The transceiver 130 or the transceiver 140 transmits and receives signals in a wireless manner. The transceiver 130 or the transceiver 140 may also perform operations such as low noise amplifying, impedance matching, frequency mixing, up and down frequency conversion, filtering, amplification and similar operations.

The transceiver 130 may receive a wireless signal. Here, the wireless signal is, for example, a satellite signal corresponding to the satellite station. The signal processing module 121 may determine whether the wireless signal includes a mobile network signal or other types of interference signals. In general, a frequency band of the satellite signal is between 3.61 and 4.2 gigahertz (GHz). Accordingly, the signal processing module 121 can determine whether the received wireless signal includes the mobile network signal. Specifically, the signal processing module 121 may determine that the wireless signal includes the mobile network signal in response to a first power of the wireless signal in a first frequency band being greater than a first threshold. The first frequency band is, for example, between 3.3 and 3.57 GHz, but the disclosure is not limited to thereto. The signal processing module 121 may determine whether the received wireless signal includes other types of interference signals other than the mobile network signal. Specifically, the signal processing module 121 may determine that the wireless signal includes an interference signal in response to a second power of the wireless signal in a second frequency band being greater than a second threshold. The second frequency band is, for example, between 15 and 29 MHz (i.e., the interference signal is a microwave signal), or between 0 and 10 MHz (i.e., the interference signal is a narrowband signal). The disclosure is not limited in this regard.

The demodulating module 122 may demodulate the mobile network signal to obtain a base station identity in response to the wireless signal including the mobile network signal. The base station identity may indicate a base station that transmits the mobile network signal. The output module 123 may output the base station identity to notify an administrator of the satellite station. For example, the output module 123 may output the base station identity to a mobile phone of the administrator of the satellite station according to a simple mail transfer protocol (SMTP) or a short message protocol (SMP) to notify the administrator that the satellite station is interfered by a specific base station. As another example, the output module 123 may output the base station identity to an external map information system, so that the external map information system displays the base station corresponding to the base station identity on a map as a reference for the administrator.

The Interference signal in the wireless network signal may include the mobile network signal and other types of interference signals. In an embodiment, the electronic device 100 may locate the interference source corresponding to the mobile network signal according to a time difference of arrival (TDOA). Specifically, the transceiver 130 and the transceiver 140 may be installed in different locations. The transceiver 130 may receive the mobile network signal in the wireless signal at a first time point, and the transceiver 140 may receive the mobile network signal in the wireless signal at a second time point. The signal processing module 121 may calculate the time difference of arrival according to the first time point and the second time point, and obtains location information corresponding to the base station identity in the mobile network signal according to the time difference of arrival. The output module 123 may output the location information according to the simple mail transfer protocol or the short message protocol, or may output the location information to the external map information system so that the external map information system displays the base station corresponding to the location information on the map.

In an embodiment, the electronic device 100 may locate the interference source corresponding to the other types of interference signals according to the time difference of arrival. Specifically, the transceiver 130 and the transceiver 140 may be installed in different locations. The transceiver 130 may receive the interference signal in the wireless signal at the first time point, and the transceiver 140 may receive the interference signal in the wireless signal at the second time point. The signal processing module 121 may calculate the time difference of arrival according to the first time point and the second time point, and obtains location information corresponding to the interference signal according to the time difference of arrival. The output module 123 may output the location information according to the simple mail transfer protocol or the short message protocol, or may output the location information to the external map information system so that the external map information system displays the interference source corresponding to the location information on the map.

FIG. 2 is a flowchart illustrating a method for monitoring an interference source of a satellite station according to an embodiment of the disclosure. The method may be implemented by the electronic device 100 shown by FIG. 1. In step S201, a wireless signal is received. In step S202, whether the wireless signal includes a mobile network signal is determined. In step S203, the mobile network signal is demodulated to obtain a base station identity in response to the wireless signal including the mobile network signal. In step S204, the base station identity is outputted.

Based on the above, the disclosure may determine whether the wireless signal includes other interference signals other than the satellite signal according to the power of the received wireless signal in each frequency band. The interference signal includes, for example, the mobile network signal. The disclosure can demodulate the mobile network signal to obtain the base station identity, so as to determine the base station which interferes the satellite station according to the base station identity. The disclosure can locate the location of the interference source through the TDOA technology, and can notify the administrator of the satellite station, or display the interference source on the map through the external map information system.

Although the present disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

To the claims:

1. An electronic device for monitoring an interference source of a satellite station, comprising:
a first transceiver, receiving a wireless signal;
a non-transitory computer-readable medium, storing a plurality of modules; and
a processor, coupled to the non-transitory computer-readable medium and the first transceiver, and accessing and executing a plurality of modules, wherein the modules comprise:
a signal processing module, determining the wireless signal includes a mobile network signal in response to a first power of the wireless signal in a first frequency band being greater than a first threshold, and determining the wireless signal includes an interference signal in response to a second power of the wireless signal in a second frequency band being greater than a second threshold, wherein the first frequency band is between 3.61 and 4.2 GHz and the second frequency band is between 15 and 29 MHz; and
a demodulating module, demodulating the mobile network signal to obtain a base station identity in response to the wireless signal including the mobile network signal; and
an output module, outputting the base station identity.

2. The electronic device of claim 1, wherein the first transceiver receives the mobile network signal in the wireless signal at a first time point, and the electronic device further comprises:
a second transceiver, coupled to the processor, wherein the second transceiver receives the mobile network signal in the wireless signal at a second time point, wherein
the signal processing module calculates a time difference of arrival according to the first time point and the second time point, and obtains location information corresponding to the base station identity according to the time difference of arrival.

3. The electronic device of claim 2, wherein the output module outputs the location information.

4. (canceled)

5. (canceled)

6. The electronic device of claim 1, wherein the first transceiver receives the interference signal in the wireless signal at a first time point, and the electronic device further comprises:
a second transceiver, coupled to the processor, wherein the second transceiver receives the interference signal in the wireless signal at a second time point, wherein
the signal processing module calculates a time difference of arrival according to the first time point and the second time point, and obtains location information corresponding to the interference signal according to the time difference of arrival.

7. The electronic device of claim 6, wherein the output module outputs the location information.

8. The electronic device of claim 1, wherein the output module outputs the base station identity according to one of a simple mail transfer protocol and a short message protocol.

9. A method for monitoring an interference source of a satellite station, comprising:
obtaining a wireless signal;
determining the wireless signal includes a mobile network signal in response to a first power of the wireless signal in a first frequency band being greater than a first threshold, and determining the wireless signal includes an interference signal in response to a second power of the wireless signal in a second frequency band being greater than a second threshold, wherein the first frequency band is between 3.61 and 4.2 GHz and the second frequency band is between 15 and 29 MHz;
demodulating the mobile network signal to obtain a base station identity in response to the wireless signal including the mobile network signal; and
outputting the base station identity.
